(19) United States
(12) Patent Application Publication
(10) Pub. No.: US 2002/0152092 A1
(43) Pub. Date: Oct. 17, 2002

(54) Method and system of making a decision including but not limited to a purchase, rental or lease

(76) Inventors: Greg Bibas, Stamford, CT (US); Richard J. Roll, Stamford, CT (US); Patricia Marlin, Sandy Hook, CT (US); Kate Pagram, Norcross, GA (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 10/094,143

(22) Filed: Mar. 8, 2002

Related U.S. Application Data
(60) Provisional application No. 60/273,851, filed on Mar. 8, 2001.

(51) Int. Cl. G06F 17/60

(52) U.S. Cl. 705/1

(57) ABSTRACT

A method and a system for making a decision, such as a purchase, is provided. The system and methodology is provided for evaluating information about a potential decision, and generating, and preferably storing, individualized user preferences related to the decision option(s) for assisting the user in making a decision regarding the decision options(s) being evaluated.

### RELATED APPLICATION

This application claims priority of U. S. provisional patent application No.: 60,273,851 filed on Mar. 8, 2001.

### BACKGROUND OF THE INVENTION

1. Field of the Invention

The present invention relates to data applications, wireless communications, location based information, and systems designed to help a user make a decision. In particular, the present invention relates to a method and a system for providing a user with a system and methodology for evaluating particular information about a potential purchase and/or decision, and storing preferences related to particular choices to assist that user to make a decision relating to the purchase and/or decision of one of the choices available to the user.

2. Description of the Related Art

There are various decision tools that are used to help a user make a particular decision about a purchase. These tools include systems, which are designed to provide access to, sort, prioritize and produce information for the decision making process. These tools are typically used in applications including, but not limited to, real estate purchases.

Examples of real estate purchase decision making tools available to a user include raw data, such as demographic information, recent sales data, Multiple Listing Service data (MLS), information provided by a Real Estate Agent, owner/seller, as well as information created by a user from their own impression of a particular property. Additional sources of data include processed data, such as an appraisal report, targeted school report for a particular district, information about taxes, crime, sales history report and property hazard report, to name a few.

In addition, currently there are services on the Internet, which provide access to MLS data, and link other data sources, such as school information and previous sales information, as well as to the MLS listings to provide additional convenience to the user.

These various sources for raw, processed, and aggregated data may each be used to provide some help to assist the user reach a decision. However, since the user's input, such as, for example, a personal preference, is not factored into the decision-making process in an organized manner, the relevance of any one piece of data as it relates to purchase and decision choices is intermingled with other information relating to the numerous purchase options. Thus, the personal preference of the user may not be factored into the final decision-making process or may not be appropriately weighted in the final decision-making process.

The typical decision-making process used by a purchasing consumer is not optimal. It requires significant effort on the part of the consumer to remember and sort the various decision-making components relevant to the particular user. For example, the normal process of purchasing a home requires countless visits to different homes, often spread out over a period of time, with less than optimal data gathering (e.g., note-taking) or objective data review taking place. There are also many instances where multiple visits to a home are not possible or practical and the potential purchaser needs to make decisions very quickly (e.g., relocating, tight housing market). A similar decision-making process is typically required in purchasing an automobile.

Thus, there is a need for a method and/or system of aggregating, sorting, storing and prioritizing the various pertinent data used for making decisions (e.g., purchasing decisions) involving multiple choices. Such a method and/or system needs to be comprehensive, iterative, objective, correlate directly to an individual user's subjective value of particular features (i.e., preferences) with the available choices, and account for the appropriateness of the available choices to an individual user.

### SUMMARY OF THE INVENTION

It is an object of the present invention to provide a method and a system that aggregates and sorts data used in determining a selection made from among multiple choices based, at least in part, on a preference of a user.

It is yet another object of the present invention to provide such a method that allows a user to input answers to specific questions, that produces an individualized, customized purchase evaluation.

It is still another object of the present invention to provide a method that allows a user to use a customized purchase evaluation to evaluate various purchase options.

It is another object of the present invention to provide such a method that incorporates access to external databases of information coordinated by a system host.

It is a further object of the present invention to provide a method for a user to review his/her evaluation of purchase choices remotely, as well as to have access to information related to the purchase choices and available from databases external to the system of the present invention.

It is still a further object of the present invention to provide such a method that permits data and details about the purchase options to be stored by the system.

These and other objects and advantages of the present invention are achieved by a method that includes creating a customer record that has an evaluation that accounts for the user's one or more personal preferences; reviewing various potential decision and purchase options; evaluating purchase and decision options using the evaluation form; and providing the evaluation results to an user. The method preferably includes presenting an evaluation of the evaluated purchase options for assisting the decision-making of the user, which evaluation is preferably organized, combined, and prioritized. The system and method preferably utilizes algorithms for determining/modeling the evaluation process. The system and method also preferably provides a mechanism for a user to access their evaluation information, as well as other information, available through a database(s).

The method and system of the present invention provides functionality to request and receive data relevant to a decision making process by wireless communication protocols from, for example, residential and commercial real estate property signage.

The method and system of the present invention, in an aspect thereof, provides the capability to request and receive data based on the requesting user's location. Requested data, preferably in the form of a structured query, may include, but is not limited to, a type, specification, price, model number, manufacturer, and age of, for example, a possible purchase option. The requested data may be provided for a geographic area based on the user's location (e.g., data related to possible purchase choices within a two mile radius of the user can be presented to the user). The data requested may be retrieved from local and remote data stores. The location determination aspect of the present invention can be provided by a tracking and locating Location Based System (LBS) that uses a terrestrial and/or satellite based system using GPS (global positioning satellites), RF transmitters/receivers, and other methods and systems. The LBS may employ triangulation and/or other methods for determining the location of a user.

While the present invention will be discussed primarily in the context of providing a method and system for assisting a user aggregate, sort, store, and prioritize data used in determining the purchase of residential real estate, the present invention can be adapted to a number of other applications. The other applications can include, but are not limited to, assisting users to choose consumer products such as automobiles, boats, home entertainment systems and other consumer electronic products, computer systems and equipment, appliances, investments, investment accounts, savings accounts, mortgages, retirement localities, education/school attendance choices, as well as other user purchase related decisions and more generally, to complex decision processes having multiple variables. In addition, the relevant applications include, but are not limited to, assisting users choose business related products and services, including financing, choosing a business location, selecting employees to hire, choosing benefits plans, as well as other business related decisions. The method and system of the present invention may be extended to encompass other complex life decisions such as, for example, selection of a course of medical treatment in response to a medical diagnosis.

### BRIEF DESCRIPTION OF THE DRAWINGS

FIG. 1 is a top level depiction of the present invention;

FIG. 2 is a depiction of a local processing device of the invention of FIG. 1;

FIG. 3 is a depiction of a remote display system aspect of the invention of FIG. 1;

FIG. 4 is a depiction of a host system of the invention of FIG. 1;

FIG. 5 is a data structure for a Broker Database of FIG. 4 for the example of the use of this system in the home purchase decision;

FIG. 6 is a data structure for a Agent Database of FIG. 4 for the example of the use of this system in the home purchase decision;

FIG. 7 is a depiction of the computer hardware of FIG. 2 and its relation to the data transfer and mobile data terminal;

FIG. 8 is a data structure for the Customer Record, Survey Answers, and Evaluation Table databases of the Customer Database of FIG. 4;

FIG. 9 is a data structure for the Customer Record of FIG. 8 for the example of the use of this system in the home purchase decision;

FIG. 10 is a data structure for the Survey Answers of FIG. 8 for the example of the use of this system in the home purchase decision;

FIG. 11 is a data structure for the Evaluation table of FIG. 8 for the example of the use of this system in the home purchase decision;

FIG. 12 is a data structure for the Survey Database of FIG. 4 for the example of the use of this system in the home purchase decision;

FIG. 13 is a data structure for the Evaluation Database of FIG. 4 for the example of the use of this system in the home purchase decision;

FIG. 14 is a flow diagram of the top level user and data process in accordance with the present invention;

FIG. 15 is a flow diagram of a preferred method for asking survey questions and producing purchase Evaluation questions in accordance with the present invention;

FIG. 16 is a flow diagram illustrating the user process of answering pre-stored survey questions in order to create a customized purchase evaluation form in accordance with the present invention;

FIG. 17 is a flow diagram illustrating the user process of answering pre-stored evaluation questions in the process of reviewing various potential purchase choices in accordance with the present invention;

FIG. 18 is a flow diagram of an aspect of the present invention for transmitting the evaluation information stored within the mobile device to be stored in the Host system;

FIG. 19 illustrates a detailed view of the location based system of FIG. 1;

FIG. 20 is a logical flow diagram of a method in accordance with the present invention, including locating the position of a user;

FIG. 21 is a logical flow diagram of a method in accordance with the present invention, including beaming data directly to the handheld device of a user; and

FIG. 22 illustrates a detailed view of Beaming Technology System 2000 of FIG. 1.

### DETAILED DESCRIPTION OF THE INVENTION

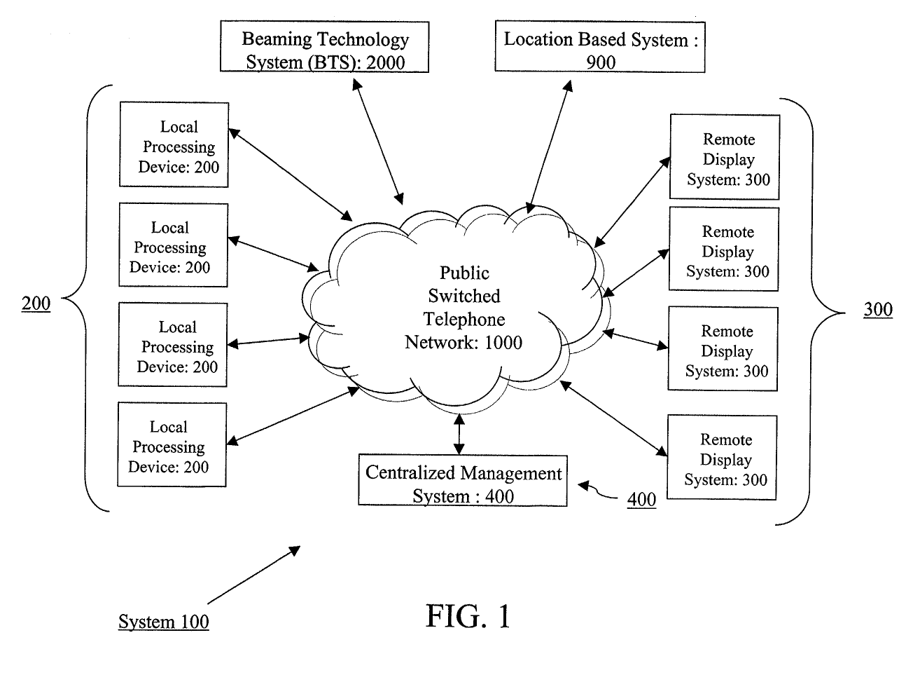

Referring to the drawings and, in particular, to FIG. 1, there is shown an embodiment of a system 100 of the present invention. System 100 provides a user with a methodology for evaluating particular data about a potential purchase and storing one or more user preferences related to a purchase option to assist the user in making a decision related to the selection of an available purchase choice or decision option. System 100 has at least one local processing device 200; a communications network 1000, in this particular embodiment a public switched telephone network (hereinafter PSTN); one or more remote display systems 300; a Location Based System (hereinafter LBS) 900; and a host system 400. Host system 400, local processing device 200, LBS 900, and one or more remote display systems 300 are preferably connected to communications network 1000 through bi-directional communication links.

System 100 accommodates data requests from the user through a local processing device 200. LBS 900 may also be used in the generation of an evaluation question. For example, the location of a user, as determined by LBS 900, may be a determining factor in the evaluation question generated by system 100. Based on the information obtained via local processing device 200 and optionally LBS 900, a customized set of purchase evaluation questions can be generated and used by the system 100 for decision-making evaluation purposes.

Responses to the evaluation questions, as they relate to each of the various purchase options, are provided to system 100 by the user through local processing device 200. These responses are preferably stored in host system 400, which is also called a centralized management system (CMS). Host system or CMS 400 preferably organizes and prioritizes the various purchase and decision options based, at least in part, on the individualized evaluation question responses provided by the user. The evaluation question responses provided by the user and other data available from data stores internal and/or external to system 100 can be used to form the basis of the organization and prioritization of the various purchase and decision options. Data of system 100, including data stored in host system 400 can preferably be accessed from one remote display system 300 for presentation of recommended selections based on the individualized, aggregated evaluation information related to each purchase decision options.

Although depicted in FIG. 1 as a PSTN, it should be appreciated that communications network 1000 can include a computer network such as the Internet or a LAN. The communications network 1000 can also include a wired or wireless communication link and/or network. Furthermore, the communication protocol used by communications network 1000 can vary, depending on, for example, the particular application.

Users of system 100 can typically access the system using local processing device 200 to enter individual user data and evaluate real estate purchase decision options. Access can also be gained using LBS 900 to provide the user's location for the purpose of retrieving data applicable to the user's location. One remote display system 300 can be used to access the system and to evaluate user generated data and other data related to the real estate or other purchasing options being evaluated by system 100. Local processing device 200 preferably provides a user interface to facilitate input of data in response to questions asked of a user, such as for example, establishing a set of evaluation questions based on the user's preferences.

A user interested in reviewing data previously entered into system 100 may access the stored information using one remote display system 300. The transfer of data between local processing device 200, LBS 900, remote display system 300, and host system 400 is preferably controlled by host system 400. Host system 400, in controlling such data transfers, can coordinate and limit the type and amount of data transferred.

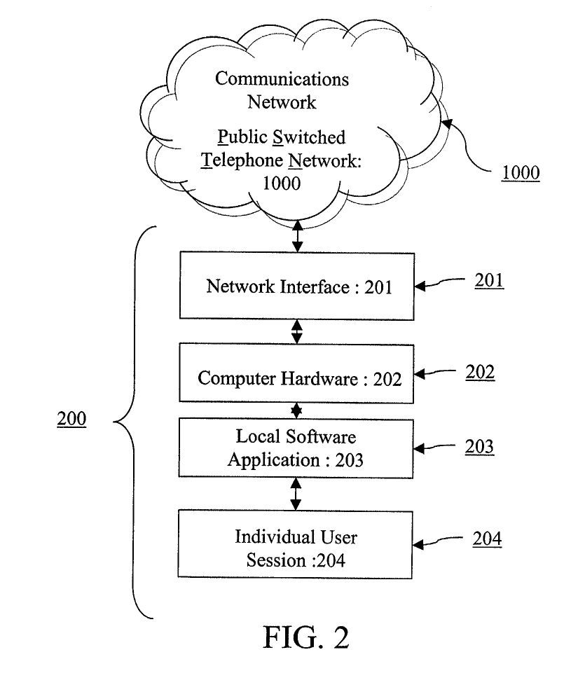

An exemplary block diagram of an embodiment of local processing device 200 is depicted in FIG. 2. Typically, a user initiates an individual user session 204 on local processing device 200, optionally with the assistance of LBS 900. LBS 900 can be used to determine the location of the user. Local processing device 200 can be a personal computer, an Internet appliance, a handheld processor-enabled device, a PDA, a mobile phone, or other device that can communicate electronic information. Typically, a local software application 203 operating with hardware 202 provides user interface support on local processing device 200. A network interface 201 facilitates linking local processing device 200 to host system 400 for the exchange of data between local processing device 200 and other components of system 100 using communication network 1000.

The user can enter information into local processing device 200 in a number of different ways, depending on the particular type of the local processing device used and the preferences of the user. Such input devices include, but are not limited to, a keyboard, a mouse, a menu control, a scanning device, a voice recognition system, a stylus, and other data input methods and controls, whether electronic or manual in nature.

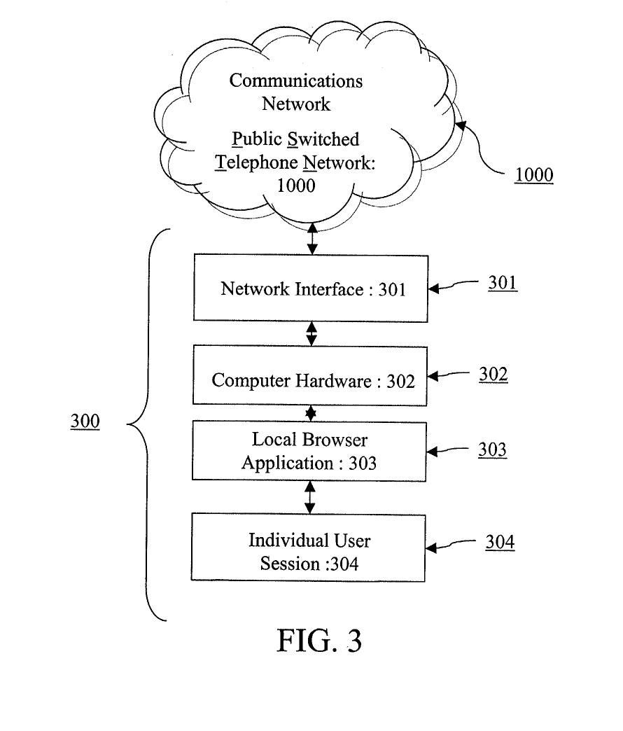

FIG. 3 illustrates a preferred embodiment of one remote display system 300. Once a user has entered pertinent information about the various real estate options being evaluated by system 100 into the system using local processing device 200 and the information is stored therein, the user can access the entered information. A user may also access other data related to the real estate or other purchase options from remote display system 300.

In an aspect of the present invention, a user initiates an individual user session 304 for retrieving stored real estate or other evaluations using remote display system 300. Remote display system 300 can be a personal computer, an Internet appliance, a PDA, a handheld PC, a mobile phone, or other devices that can communicate electronic information. A local browser application 303 can provide a user interface on remote display system 300. Local browser application 303 and/or other software accesses and controls the associated hardware 302 of remote display system 300. Network interface 301 facilitates access and communication to communications network 1000 for connecting remote display system 300 to host system 400.

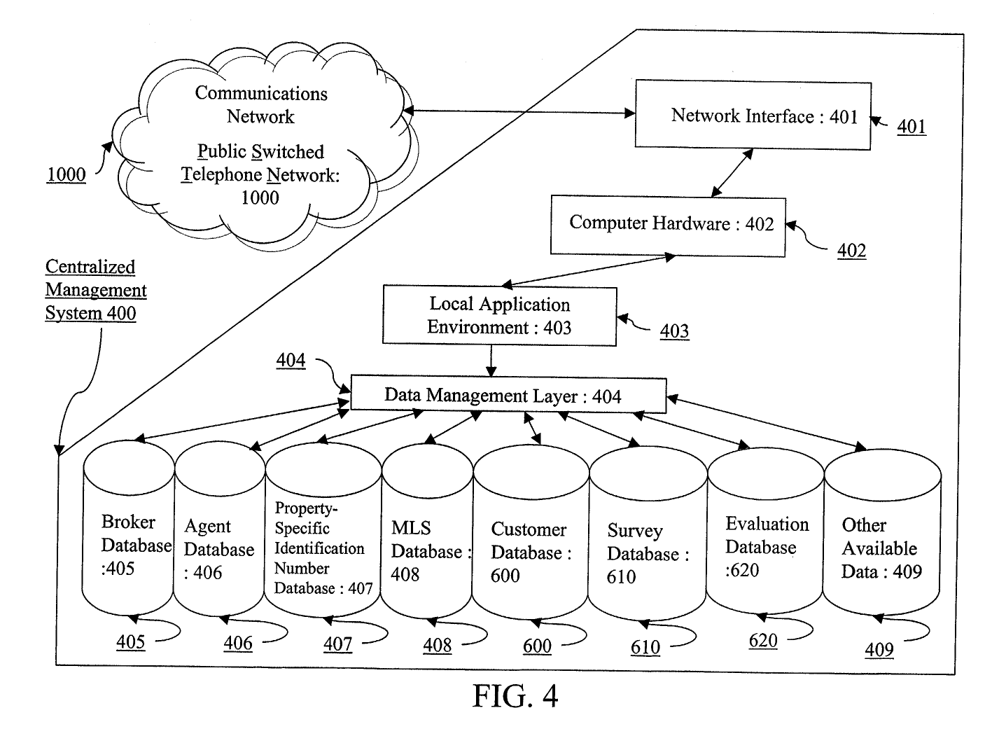

FIG. 4 illustrates an aspect of host system 400. Various data repositories 405 through 409, 600, 610, and 620 of host system 400 are controlled by data management layer 404 of host system 400. Data management layer 404 acts to control the flow, access and storage of the data stored in the data repositories. Data management layer 404 preferably resides in a local application environment 403 that runs on associated computer hardware 402. Although expressed as hardware, the computer platform supporting the local application environment 403 may employ a combination of software and/or hardware units to facilitate the operation of host system 400. A network interface 401 provides a communication interface with the communications network 1000.

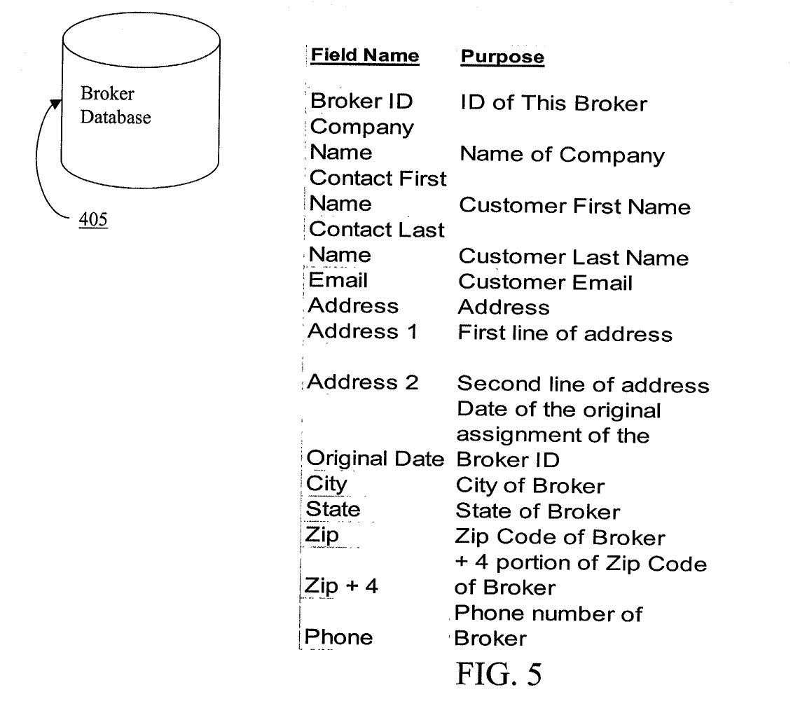

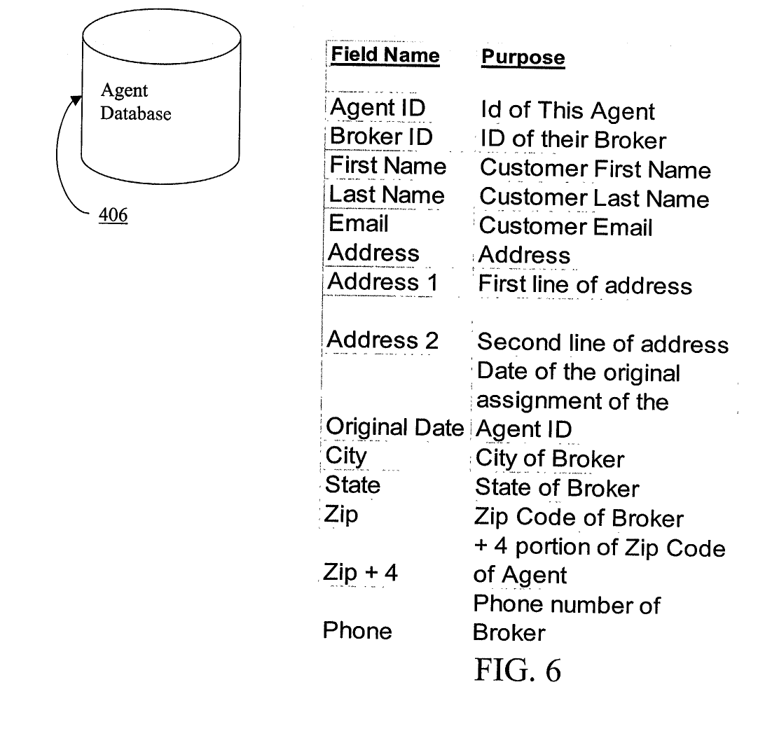

FIGS. 5 and 6 are data structures for an exemplary broker database 405 of FIG. 4 for use by the present invention in the context of a real estate purchasing decision. Broker database 405 includes fields for the identification of brokers using system 100. Broker database 405 can be used to control access to system 100, thereby limiting the type and amount of access available to brokers. Exemplary fields for broker database 405 and agent database 406 are shown in FIGS. 5 and 6, respectively. Note that the various data fields may be modified to include other broker and agent identifying data in addition to and/or in lieu of the particular data types depicted in FIGS. 5 and 6.

In operation, requests and responses from local processing device 200 are preferably routed to host system 400. Requests are fulfilled by host system 400 through data management layer 404. The request fulfillment is based on the availability of the requested information in or accessible to host system 400. User responses to questions, preferably inputted via local processing device 200, are preferably stored in host system 400 for use in evaluating purchase selection options.

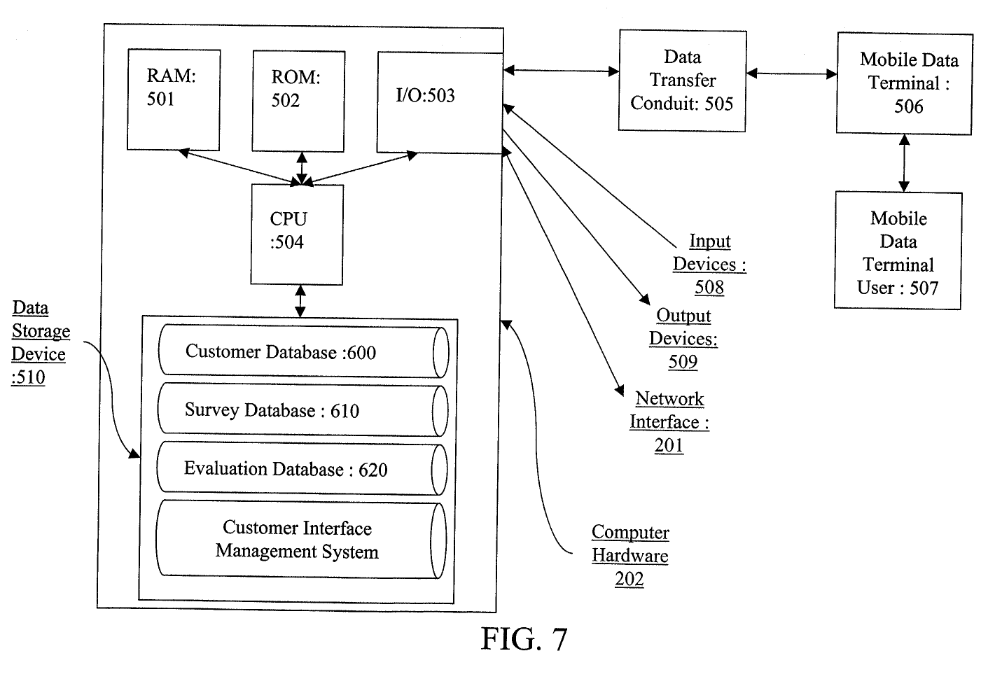

FIG. 7 illustrates an exemplary detailed depiction of the computer hardware 202 associated with the local processing device 200 of FIG. 2. As shown, exemplary computer hardware 200 includes a random access memory (RAM) 501; a read only memory (ROM) 502; an input/out (I/O) interface 503 for coupling to input device 508, output device 509, a data transfer conduit 505, and a network interface 201; and a microprocessor (e.g., a CPU 504) for controlling and coordinating the operation of local processing device 200. Also included in computer hardware 202 is a data storage device 510. Data storage device 510 provides local data storage capabilities for storing data used by local processing device 200. Data storage device 510 can contain multiple databases for storage of different types of data. For example, data storage device 510 can contain storage areas (e.g., real and/or virtual disk subsystems) for customer database 600, a survey database 610, an evaluation database 620, and a customer interface management system 630.

The I/O interface 503 can be interfaced to data transfer conduit 505 that provides a communication link to a mobile data unit 506. The data transfer link may be a wired or wireless communication link. Mobile data terminal 506 is preferably a portable computing device, such as a PDA (personal digital assistant), programmed to provide a mobile data terminal user 507 with the capability of submitting user input to system 100.

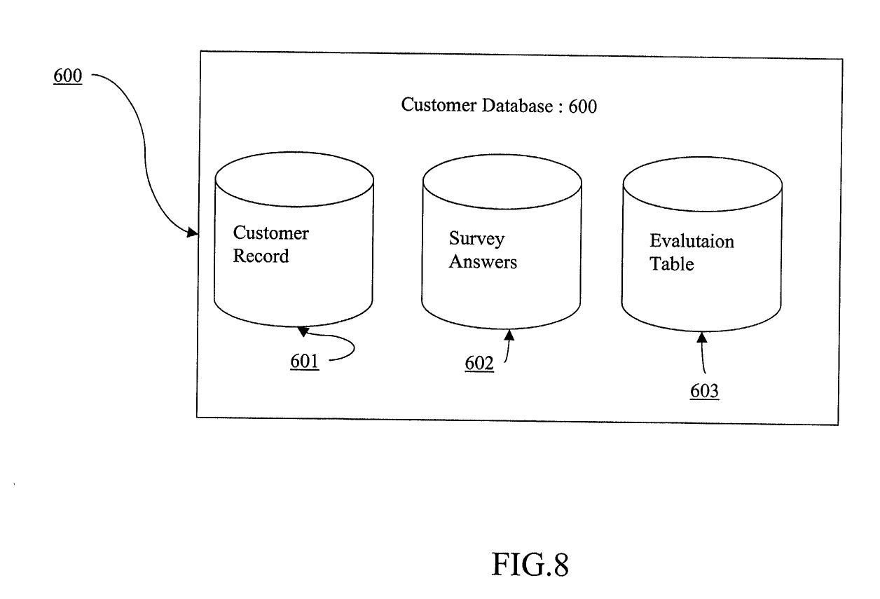

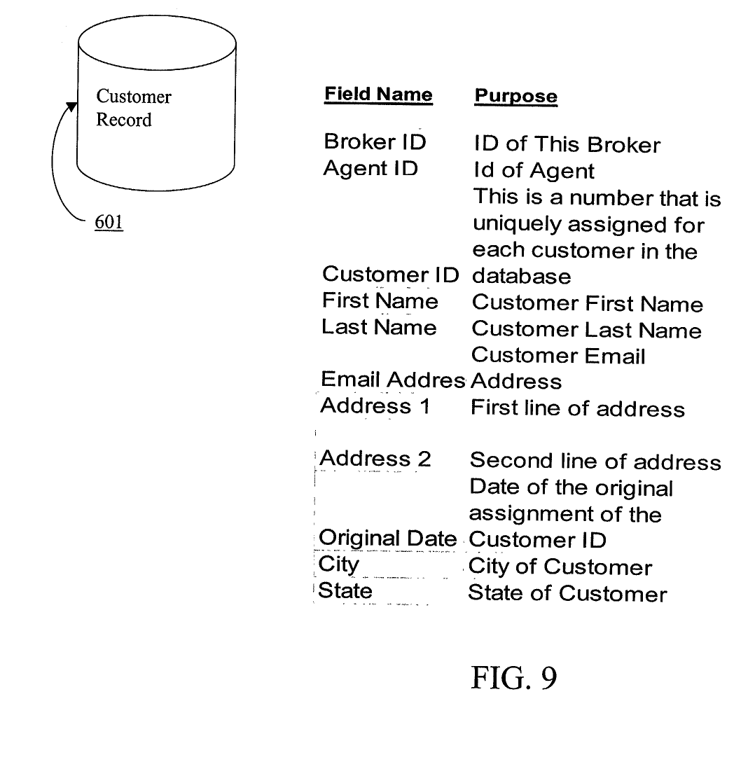

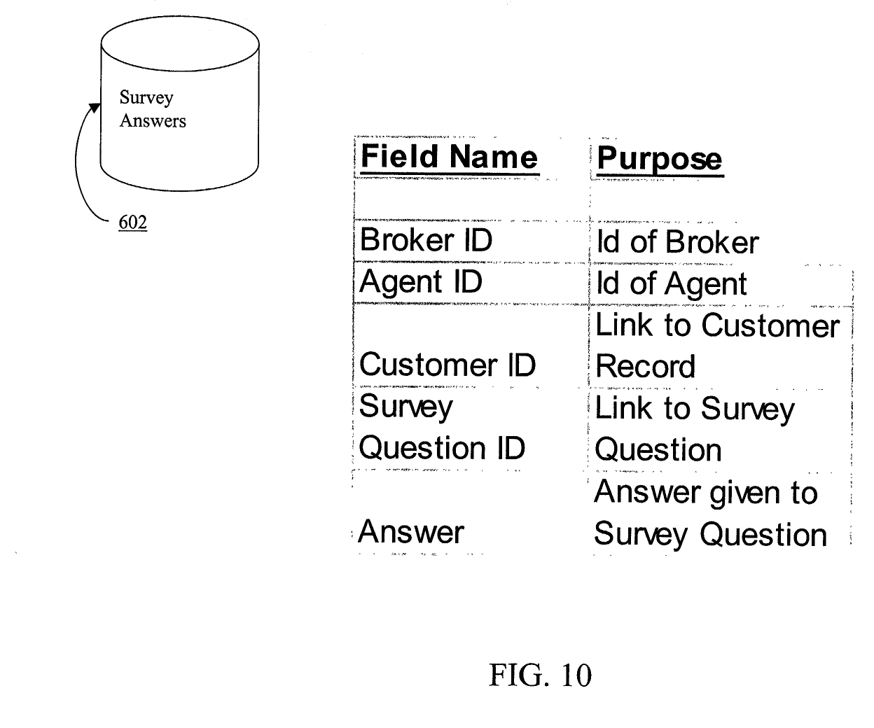

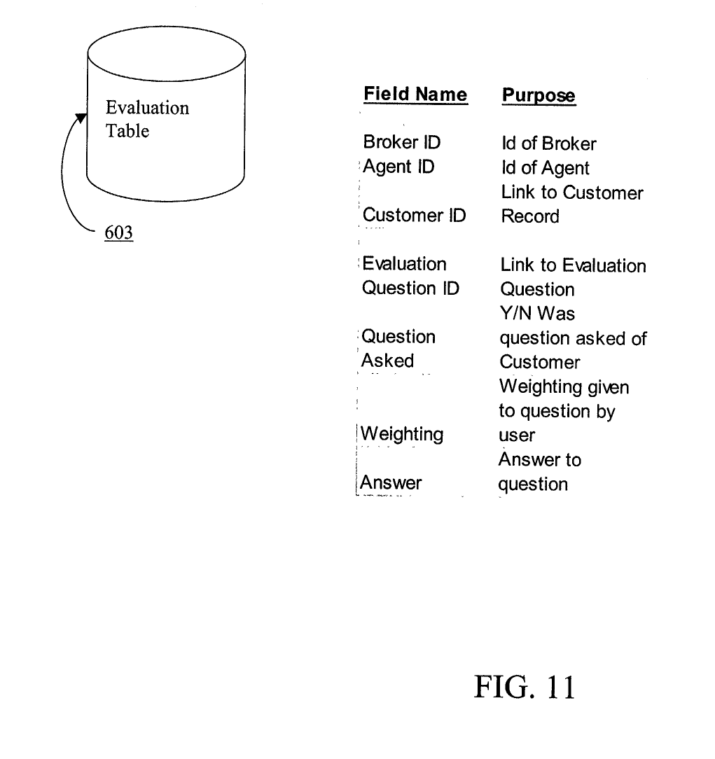

Illustrative examples of the various databases used by system 100 and located in data storage device 510 are shown in FIGS. 8 through 13. FIG. 8 illustrates customer database 600 that has, but is not limited to, a customer record 601, survey answers 602, and an evaluation table 603. Customer database 600, and the data stored therein, are accessed and used by system 100 as explained in the exemplary methods of operation discussed below. FIGS. 9 through 11 illustrate examples of data fields for the customer record database 601, the survey answers database 602, and the evaluation table database 603 comprising the customer database 600. Note that the databases shown are not limited to containing only the exemplary data fields illustrated. The data fields may be modified to include other data types.

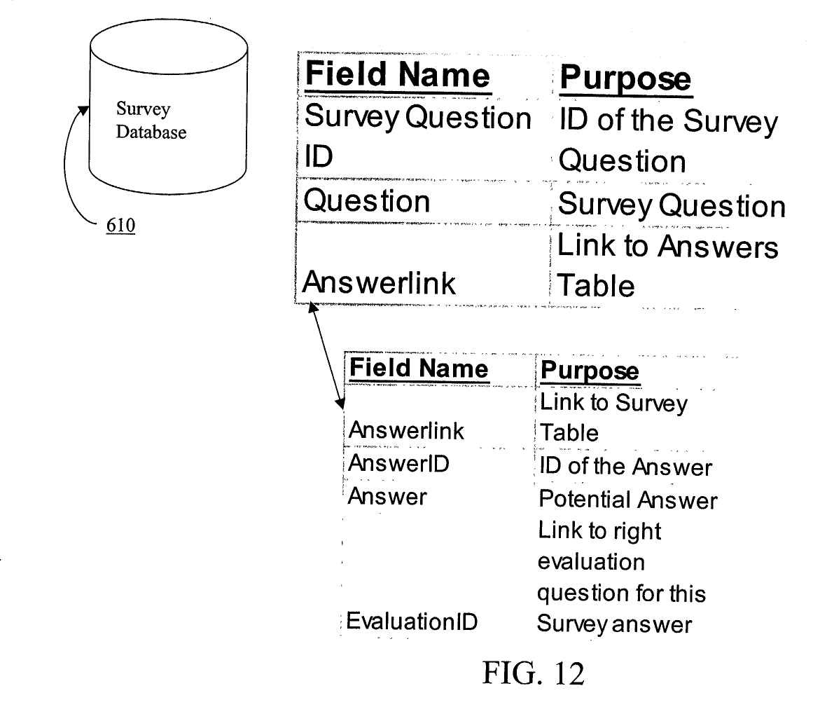

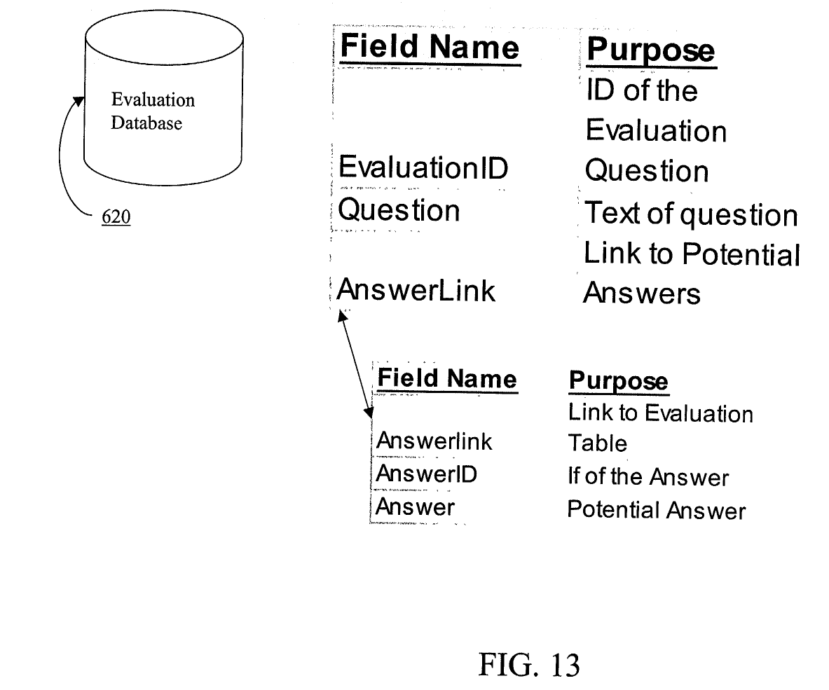

FIGS. 12 and 13 illustrate an exemplary survey database 610 and evaluation database 620, respectively, located in data storage device 510. The data fields of each database are used to contain, respectively, the survey questions and the evaluation questions of survey database 610 and evaluation database 620. Answer identifiers are included in each database 610,620 to properly associate related questions and answers.

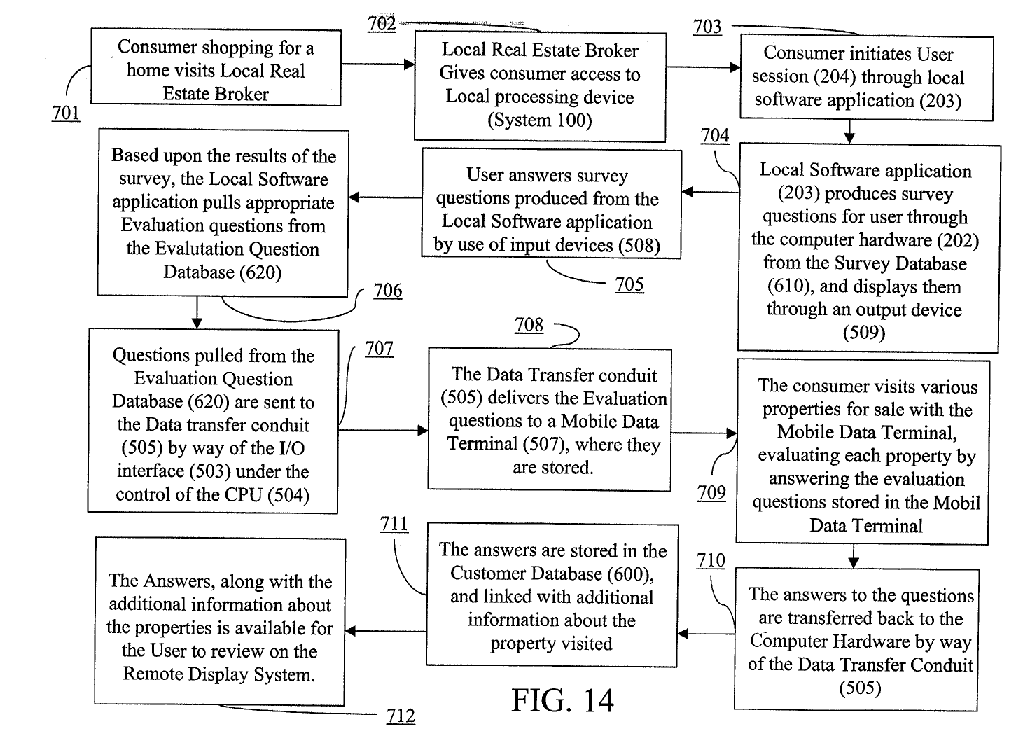

FIG. 14 is an exemplary flow diagram showing a top level functioning aspect of the decision-making method of the present invention. In step 701, a user shopping for a home visits a local real estate broker equipped with system 100. The local real estate broker gives the user access to local processing device 200 (Step 702). The user initiates a user session 204 through local software application 203 (step 703). The local software application 203 retrieves survey questions for the user to answer from the survey database 610 located, preferably, in local processing device 200. The survey questions are displayed through an output device 509, such as a display monitor or a printer, interfaced with local processing device 200. The user then provides answers to the survey questions using interfaced input device 508 of local processing device 200 (step 705). Based on the responses provided to the survey questions, local software application 203 assembles an appropriate set of evaluation questions from the evaluation question database 620 (Step 706). Based, at least in part, on the user's responses to the survey questions, the evaluation questions are chosen to include evaluation criteria identified as relevant to the user's purchasing decision-making process.

The evaluation questions are routed from local processing device 200 to mobile data terminal 506 via data transfer conduit 505 (Step 707). Data transfer conduit 505 may be a wired or wireless communication link between local display device 200 and mobile data terminal 506 for facilitating the delivery of the evaluation questions to the mobile data terminal 506 for storage (Step 708).

The user can visit multiple properties being offered for sale with mobile (i.e., portable) data terminal 506, evaluating each property by answering the evaluation questions stored therein (Step 709), preferably while at the real estate property. The responses to the questions are transferred to local processing device 200 via data transfer conduit 505 (step 710). The responses are preferably stored in customer database 600 of local processing device 200 and/or host CMS 400. Optionally, the responses may be associated with additional data related to the evaluated properties located in database 409 (Step 711). The responses to the evaluation questions, along with the optional additional data related to the evaluated properties, is available for remotely viewing by the user on remote display system 300 (Step 712).

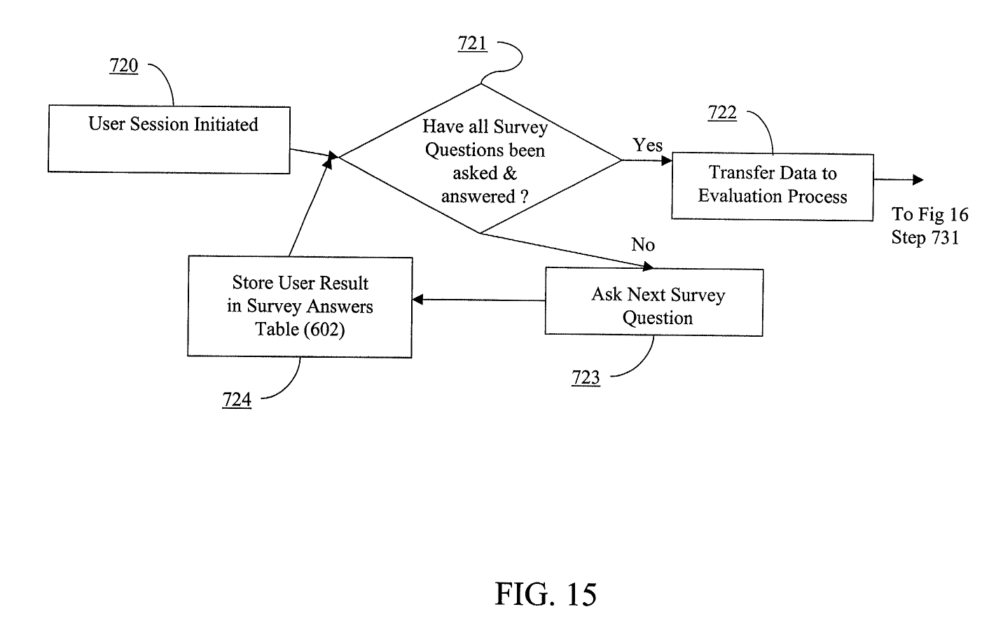

FIG. 15 is a flow diagram of an exemplary method for assuring that all of the pertinent survey questions are asked of a user so that a reliable set of evaluation questions, indicative of the user's preferences, can be assembled. A user session is initiated on local processing device 200 (step 720). Local processing device 200 evaluates the list of survey questions to be asked to determine if all of the questions have been asked of the user (Step 721). When all of the questions have not been asked of the user, the next survey question from the list is posed to the user (Step 723). The user provides an answer in response to asked questions using the input device(s) 508 of local processing device 200. Responses from the user are stored in a survey answers table 602 of customer database 600 (step 724). Customer database 600 can be located in local processing device 200 and/or host 400.

The system typically resets and continues to check whether all of the questions have been asked of the user (Step 721). This process, i.e., steps 721, 723, and 724, will repeat until all questions have been asked of the user. When the user has answered all of the questions, the system proceeds to transfer the survey question responses to the evaluation process (step 722).

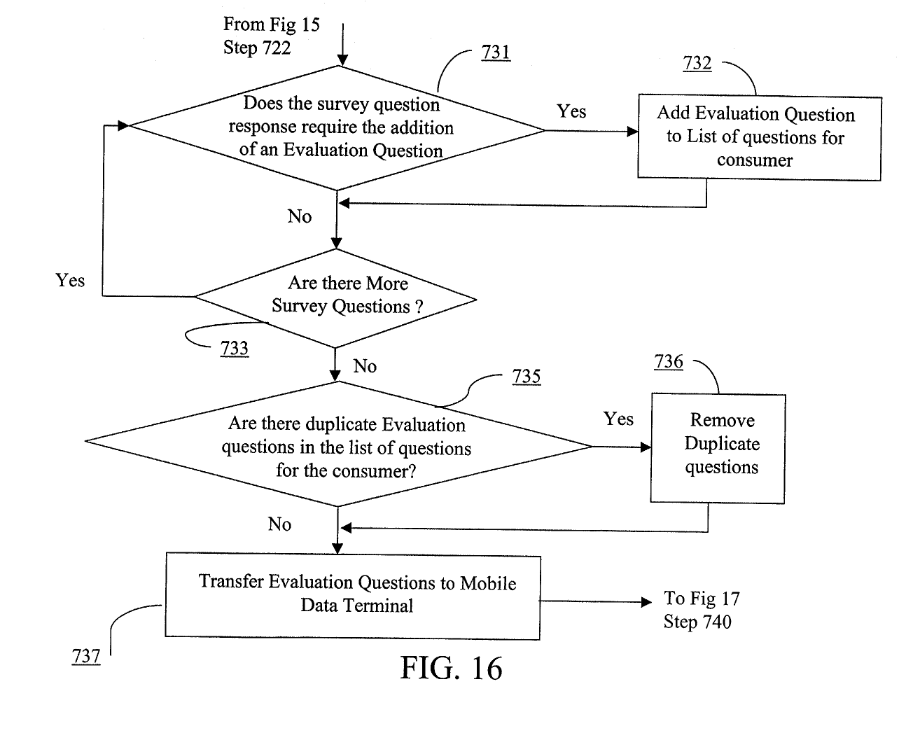

FIG. 16 is a continuation of the process initiated in FIG. 15, and illustrates the steps involved in an exemplary evaluation process. Continuing with step 722, the answers to the survey questions are transferred to the evaluation process. The evaluation process reviews the first survey question response to determine whether the response to the survey question warrants the addition of an evaluation question to the list of evaluation questions that will be used by the user in evaluating individual real estate-purchase options, (i.e., properties) (step 731). If the response warrants addition of an evaluation question to the evaluation question list, then the appropriate evaluation question(s) is added to the evaluation question list (step 732). After the initial question is reviewed by the evaluation process, the system checks to determine if there are additional survey question responses to review (Step 733). If there are additional survey questions to review (Step 733), then the system proceeds to review the next survey question (step 731). System 100 repeats steps 731 through 733 for as long as there continues to be additional survey question responses to process.

Once there are no additional survey question responses to process, system 100 proceeds to step 735 where a determination is made whether there are duplicate evaluation questions in the assembled list of evaluation questions. If there are duplicate evaluation questions, system 100 removes the duplicated questions so that there is, at most, only one of each evaluation question (step 736). When the duplicate evaluation questions, if any, have been removed from the assembled list of evaluation questions (step 736), the system proceeds to transfer the assembled list of evaluation questions to mobile data terminal 506 (step 737) for presentation thereon to the user.

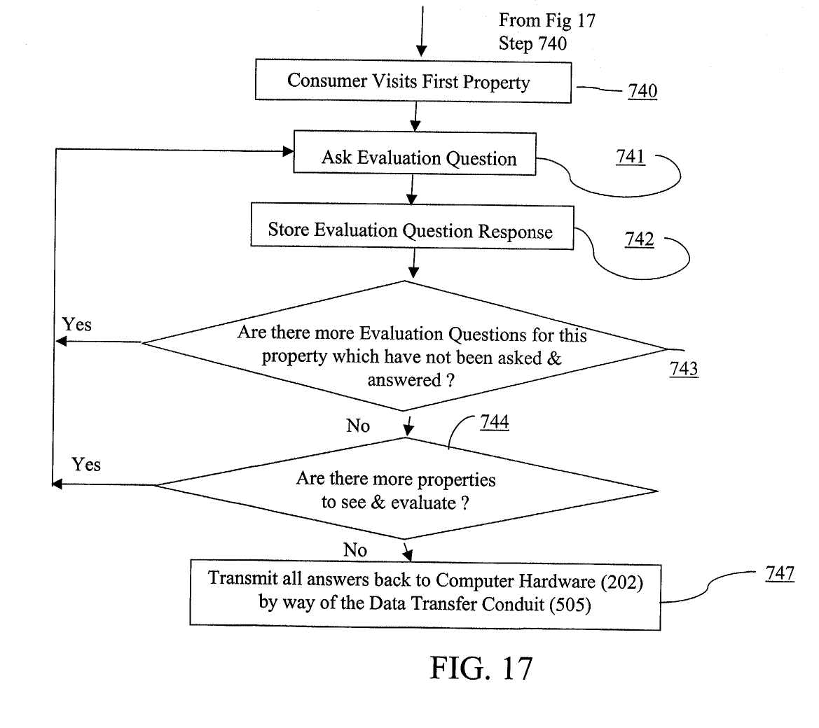

FIG. 17 is a flow diagram illustrating an exemplary method of utilizing the evaluation questions in the process of evaluating a real estate property under consideration for purchase. Once the list of evaluation questions has been transferred to mobile data terminal 507 (Step 737), the user can visit the first property they are evaluating and considering purchasing (Step 740). The user is asked the first evaluation question for evaluating the real estate property (Step 741), preferably, in an organized, prioritized, and documented manner. System 100 proceeds to store the response to the asked evaluation questions (step 742) in mobile data terminal 506. Next, a determination is made whether there are more evaluation questions to be asked of the user concerning the particular property under consideration (Step 743). If there are more questions to be asked, then system 100 proceeds to ask the additional questions (step 741) until all of the evaluation questions have been responded to and stored (step 742).

System 100 then proceeds to determine whether additional properties will be evaluated (step 744). If additional properties will be evaluated, then the user proceeds to the next property and commences the evaluation of the new property by performing steps 741 through 744, until the user has visited and evaluated all of the real estate properties being considered (i.e., there are no further properties to evaluate). When all of the properties have been evaluated, system 100 preferably transmits all of the responses to local processing device 200 via data transfer conduit 505 (step 747).

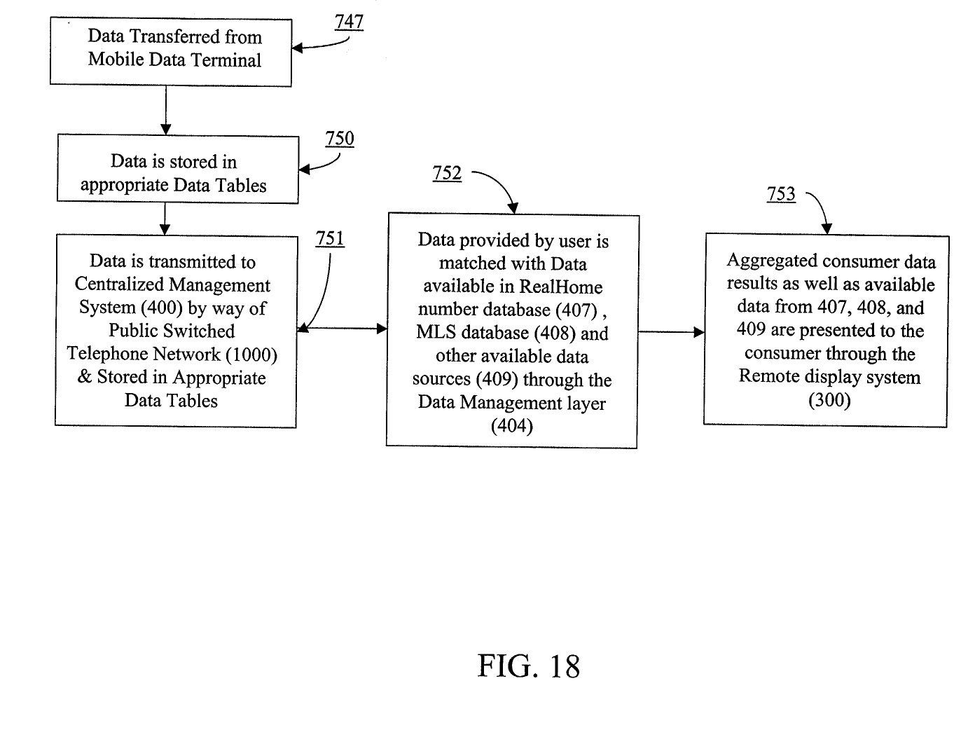

FIG. 18 is a flow diagram illustrative of an exemplary method for storing the evaluation responses obtained by system 100 (e.g., as demonstrated in the example of FIG. 17) and making the responses accessible through remote display system 300. Data stored in mobile data terminal 506 is transmitted to the computer hardware 202 of local processing device 200 via data transfer conduit 505 (step 747). Data transfer conduit 505 can be a wired and/or a wireless connection. The transferred data is preferably stored in the appropriate data tables in the local processing device 200 (step 750). Data stored in local processing device 200 can be transmitted to host system 400 via communication link 1000 and stored in the appropriate data tables in the customer database 600 (step 751). The data provided by the user can also be associated with data available in other databases of host system 400 such as, for example, the property-specific identification database 407, MLS database 408, and other available data sources 409 accessible through, for example, the data management layer 404 (step 752).

In step 753, aggregated consumer evaluation data results, as well as the data from available databases 407, 408, and 409, are presented to the user via remote display system 300 for the real estate properties being evaluated. The results are preferably presented as an organized, prioritized evaluation of the evaluated real estate choices based on the individual preferences of the user, thereby providing the user with the most relevant evaluation data for their decision-making process.

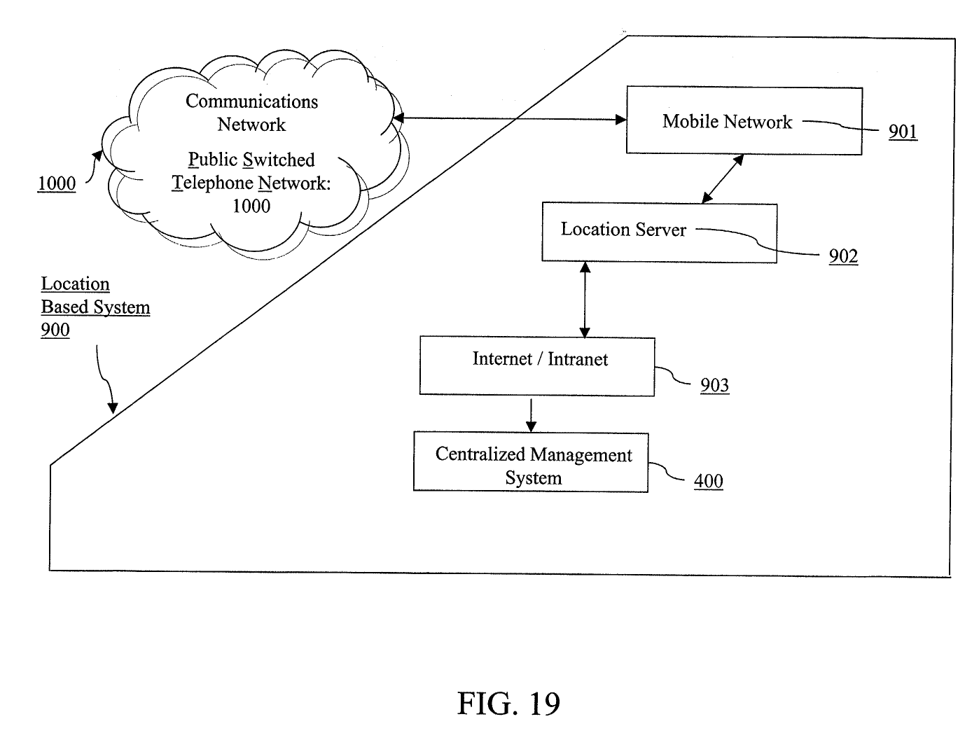

FIG. 19 illustrates an exemplary configuration of LBS 900 for determining the location of the user through a terrestrial and/or satellite based tracking and locating system. The systems and methods used by LBS 900 may include, for example, a global position satellite (GPS), a differential global position satellite (DGPS), triangulation and other location determination techniques. As shown, exemplary LBS 900 uses a mobile network 901 to communicate with location server 902. Location server 902 may in turn communicate via Intranet and/or Internet to contact host system 400. The location information determined by LBS 900 can be forwarded to host system 400 for the purpose of retrieving corresponding data related to the location and requests of the user.

In operation, requests and responses to questions from local processing device 200 are preferably routed to host system 400. The request is fulfilled or the data is stored by host system 400 through data management layer 404. The fulfillment or storage is based on the availability of the requested data or the type of data to be provided or stored.

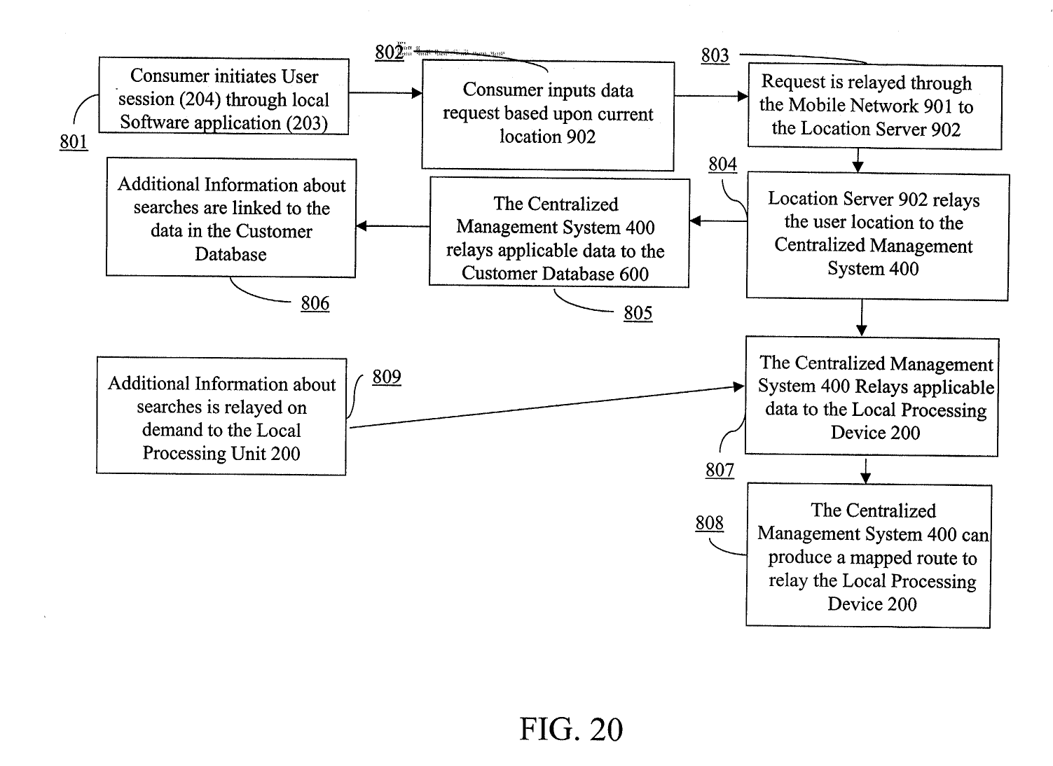

FIG. 20 is a logical flow diagram illustrative of an exemplary method of the present invention including the process of determining the location of a user. The user preferably initiates a user session in a first step (step 801). The user makes a request by inputting relevant location based data (step 802). It should be appreciated that the method of FIG. 20 may be initiated automatically without any required initiation step 802. The request is forwarded via mobile network 901 to location server 902 (step 803) that relays the user location information to host system 400 (step 804). From host system 400, the user location information can be forwarded to customer database 600 and associated with other data in customer database 600 (steps 805 and 806). In an aspect of the present invention, additional data can be linked to the search data in customer database 600 (step 806) and be made available on request by the user via local processing device 200 (step 809). Referring back to step 804, host system 400 can also forward the user location information to local processing device 200 for various uses, such as further processing, for example, generating a mapped route (steps 807 and 808).

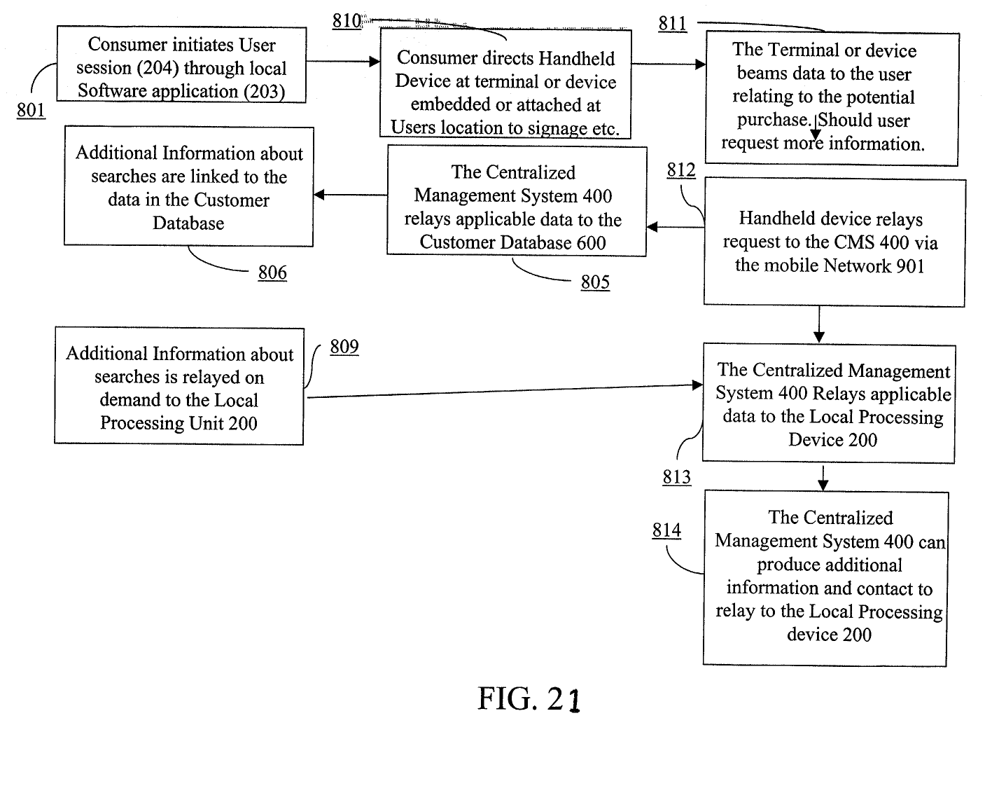

FIG. 21 is a logical flow diagram illustrative of an exemplary method of the present invention including the process of “beaming” (i.e., wirelessly transmitting) data related to real estate in accordance with an aspect of the present invention. The wireless communication protocol is preferably wireless and may employ infrared (IR), radio frequency (RF), and other wireless communication techniques and formats such as, but not limited to, TCP/IP, 802.11, and other wireless communication protocols. The user initiates a user session in a first step (step 801). The user then makes a request by optionally directing the handheld device towards the device that transmits relevant decision making data to the user (steps 810 and 811). The transmitting device is preferably attached to or embedded in an object such as, but not limited to, real estate signage, building structures, etc. The request is forwarded via mobile network 901 to host system 400, wherein information can be forwarded to the customer database 600 and associated with other data in customer database 600 (steps 805 and 806). Referring back to step 812, host system 400 can forward the user location information as well as other data (steps 813 and 814) to local processing device 200 for various uses, such as further processing, for example, requesting additional information or contact requests.

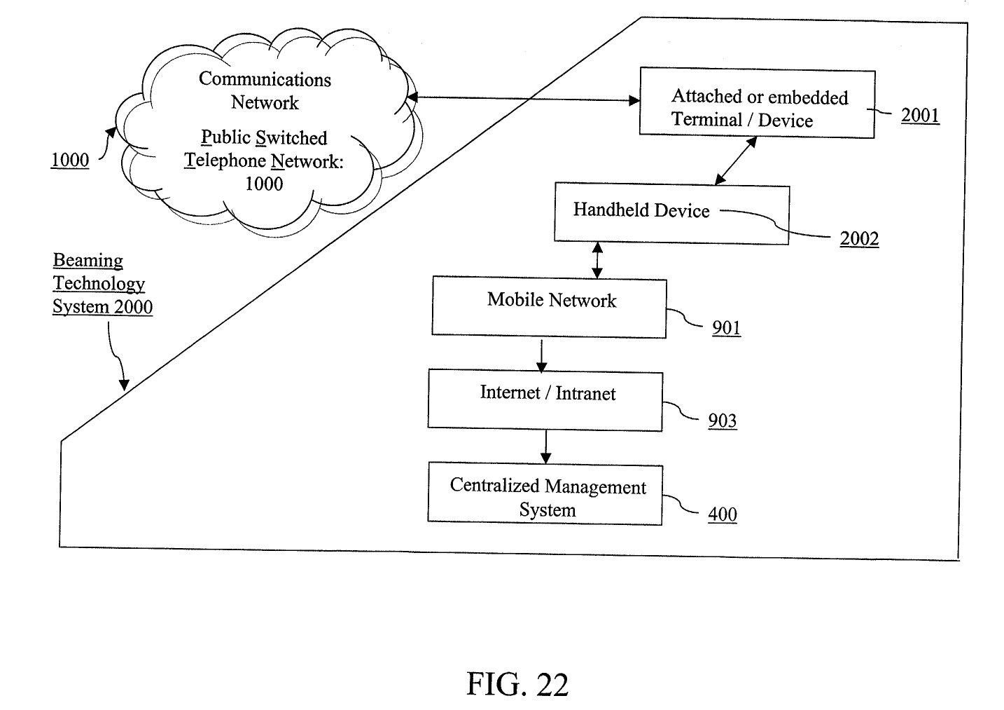

FIG. 22 illustrates an exemplary configuration of system 100 employing beaming technology system (BTS) 2000 for receiving information from suitable equipped real estate signage 2001, etc. As shown, exemplary BTS 2000 preferably operates by having devices, preferably attached to or embedded in real estate signage, communicate wirelessly with the handheld device used by the user to access the system. The user can then communicate with host system 400 via mobile network 901 and intranet and/or Internet 903 to contact CMS 400. The information received by BTS 2000 can be transmitted to host system 400 for the purpose of retrieving corresponding data related to the real estate location and data requests of the user.

It should be understood that the foregoing description is only illustrative of the present invention. Various alternatives and modifications can be devised by those skilled in the art without departing from the present invention. For example, the decision making system and method of the present invention may be implemented by a computer readable storage medium (e.g., a removable storage medium, a memory card, or a hard disk) having program instructions embodied therein for executing the methods of the present invention. The computer readable storage medium can be read and the program instructions executed by a processor. Accordingly, the decision making system and method of the present invention can be implemented by a storage medium having computer readable program instructions embodied therein for making a decision regarding a purchase of real estate. The storage medium includes program instructions for obtaining a preference of a decision maker, program instructions for evaluating the purchase of the real estate. A basis of the evaluation includes the preference, and program instructions for providing a result of the real estate evaluation to the decision maker.

While the present invention has been described largely in the context of a real estate purchase decision process, this has been done primarily for the purposes of providing a concise and illustrative, not limiting, example of the present invention. Thus, the present invention is intended to embrace all such alternatives, modification and variances, such as, for example, being adapted for use in non-real estate purchasing and decision process environments, including decisions in the context of business, finance, medical, and personal or organizational decision processes.

What we claim is:

1. A method for making a decision regarding a purchase of a piece of real estate comprising:
obtaining a preference of a decision maker;
evaluating the purchase of the real estate, wherein a basis of said evaluation includes said preference; and
providing a result of said evaluation to said decision maker.

2. The method of claim 1, further comprising generating said preference.

3. The method of claim 1, wherein said obtaining comprises eliciting a response to a query from said decision maker.

4. The method of claim 1, wherein said obtaining comprises retrieving said preference from a storage location.

5. The method of claim 1, wherein said evaluating considers an attribute of the real estate being evaluated.

6. The method of claim 1, further comprising said decision maker making a decision regarding the purchase of the real estate based, at least, on said result.

7. The method of claim 1, wherein said basis for said evaluation includes location related data of the real estate.

8. A system for making a decision regarding a purchase of real estate comprising:
an input device for obtaining a preference of a decision maker;
a processor for evaluating said purchase of a piece of real estate, wherein a basis of said evaluation includes said preference; and
a display device for providing a result of said evaluation to said decision maker.

9. The system of claim 8, wherein said processor generates said preference.

10. The system of claim 8, wherein said input device is selected from a group consisting of a computer, a handheld processor-enabled device, a personal data assistant (PDA), and a mobile phone.

11. The system of claim 8, further comprising a storage location for storing said preference.

12. The system of claim 8, wherein said display device is selected from a group consisting of a printer and a display screen.

13. The system of claim 8, further comprising a receiver for receiving a signal communicating data regarding said purchase of the real estate.

14. The system of claim 8, further comprising a location based system for obtaining data related to a location of the real estate.

15. A storage medium having computer readable program instructions embodied therein for making a decision regarding a purchase of a piece of real estate, said storage medium comprising:
program instructions for obtaining a preference of a decision maker;
program instructions for evaluating said purchase of the real estate, wherein a basis of said evaluation includes said preference; and
program instructions for providing a result of said evaluation to said decision maker.

16. The storage medium of claim 15, further comprising program instructions for generating said preference.

17. The storage medium of claim 15, wherein said program instructions for obtaining comprises program instructions for eliciting a response to a query from said decision maker.

18. The storage medium of claim 15, wherein said program instructions for obtaining comprises program instructions for retrieving said preference from a storage location.

19. The storage medium of claim 15, wherein said program instructions for evaluating include program instructions for considering an attribute of the real estate being evaluated.

20. The storage medium of claim 15, further comprising program instructions for receiving a decision from said decision maker regarding the purchase of the real estate, said decision at least based on said result.

21. The storage medium of claim 15, wherein said program instructions for providing include program instructions for providing said result to a device selected from a group consisting of a display screen, a storage location, a printer, a facsimile, and an address.

22. A method for making a decision comprising:
obtaining a preference of a decision maker;
evaluating said decision, wherein a basis of said evaluation includes said preference; and
providing a result of said evaluation to said decision maker.

23. The method of claim 22, further comprising generating said preference.

24. The method of claim 22, wherein said obtaining comprises eliciting a response to a query from said decision maker.

25. The method of claim 22, wherein said obtaining comprises retrieving said preference from a storage location.

26. The method of claim 22, further comprising said decision maker making a decision based, at least, on said result.

27. A system for making a decision comprising:
an input device for obtaining a preference of a decision maker;
a processor for evaluating said decision, wherein a basis of said evaluation includes said preference; and
a display device for providing a result of said evaluation to said decision maker.

28. The system of claim 27, wherein said processor generates said preference.

29. The system of claim 27, wherein said input device is selected from a group consisting of a computer, a handheld processor-enabled device, a personal data assistant (PDA), and a mobile phone.

30. The system of claim 27, further comprising a storage location for storing said preference.

31. The system of claim 27, wherein said display device is selected from a group consisting of a printer and a display screen.

32. The system of claim 27, further comprising a receiver for receiving a signal communicating data regarding said decision.

33. A storage medium having computer readable program instructions embodied therein for making a decision, said storage medium comprising:
program instructions for obtaining a preference of a decision maker;
program instructions for evaluating said decision, wherein a basis of said evaluation includes said preference; and
program instructions for providing a result of said evaluation to said decision maker.

34. The storage medium of claim 33, further comprising program instructions for generating said preference.

35. The storage medium of claim 33, wherein said program instructions for obtaining comprises program instructions for eliciting a response to a query from said decision maker.

36. The storage medium of claim 33, wherein said program instructions for obtaining comprises program instructions for retrieving said preference from a storage location.

37. The storage medium of claim 33, wherein said program instructions for evaluating include program instructions for considering an attribute of said decision being evaluated.

38. The storage medium of claim 33, further comprising program instructions for receiving a decision from said decision maker, said decision at least based on said result.

39. The storage medium of claim 33, wherein said program instructions for providing include program instructions for providing said result to a device selected from a group consisting of a display screen, a storage location, a printer, a facsimile, and an address.
